(19) United States
(12) Patent Application Publication
(10) Pub. No.: US 2026/0131245 A1
(43) Pub. Date: May 14, 2026

(54) GAME CONTROL FOR VIRTUAL OBJECTS

(71) Applicant: TENCENT TECHNOLOGY (SHENZHEN) COMPANY LIMITED, Shenzhen (CN)

(72) Inventor: Qin LI, Shenzhen (CN)

(73) Assignee: TENCENT TECHNOLOGY (SHENZHEN) COMPANY LIMITED, Shenzhen, GD (CN)

(21) Appl. No.: 19/441,616

(22) Filed: Jan. 6, 2026

Related U.S. Application Data
(63) Continuation of application No. PCT/CN2024/110339, filed on Aug. 7, 2024.

(30) Foreign Application Priority Data
Oct. 12, 2023 (CN) 202311321546.2

(51) Int. Cl. A63F 13/57

(52) U.S. Cl. CPC A63F 13/57

(57) ABSTRACT

In a game control method, a first game scene including a virtual object located in a virtual environment is output for display. The virtual object is associated with a virtual aircraft. The virtual aircraft is associated with flight parameters including an elapsed flight time and a maximum flight time. Based on the trigger operation performed on the movement control element, the virtual aircraft is controlled to take off in the virtual environment. Based on the first movement control operation performed on the movement control element, the virtual aircraft is controlled to move in the virtual environment based on the first movement control operation. Based on the second movement control operation performed on the direction control element, the virtual object is controlled to move in the virtual environment based on the second movement control operation.

### RELATED APPLICATIONS

The present application is a continuation of International Application No. PCT/CN2024/110339, filed on Aug. 7, 2024, which claims priority to Chinese Patent Application No. 202311321546.2, filed on Oct. 12, 2023. The entire disclosures of the prior applications are hereby incorporated by reference.

### FIELD OF THE TECHNOLOGY

Aspects of this disclosure relate to the technical field of computers, including a game control method.

### BACKGROUND OF THE DISCLOSURE

With continuous development of computer technologies, more and more types of games can be played on a terminal, content and functions of the games become progressively richer, and games now include virtual aircraft having a flight function. Examples include an unmanned aerial vehicle, a copter, a controlled gunship, a fighter, a hot balloon, and the like.

Therefore, a game control method is needed to control a virtual aircraft.

### SUMMARY

Aspects of this disclosure provide a game control method, a game control apparatus, and a non-transitory computer-readable storage medium. Examples of technical solutions of this disclosure may be implemented as follows:

An aspect of this disclosure provides a game control method. In the method, a first game scene including a virtual object located in a virtual environment is output for display. The virtual object is associated with a virtual aircraft. The virtual aircraft is associated with flight parameters including an elapsed flight time and a maximum flight time. It is determined that trigger operation is performed on a movement control element in a user interface. Based on the trigger operation performed on the movement control element, the virtual aircraft is controlled to take off in the virtual environment. It is determined that a first movement control operation is performed on the movement control element. Based on the first movement control operation performed on the movement control element, the virtual aircraft is controlled to move in the virtual environment based on the first movement control operation. It is determined that a second movement control operation is performed on a direction control element in the user interface. Based on the second movement control operation performed on the direction control element, the virtual object is controlled to move in the virtual environment based on the second movement control operation. The virtual object and the virtual aircraft are output for display concurrently in the first game scene, and the movement control element and the direction control element are concurrently displayed in the user interface.

An aspect of this disclosure provides a game control apparatus. The apparatus includes processing circuitry configured to output for display a first game scene including a virtual object located in a virtual environment. The virtual object is associated with a virtual aircraft. The virtual aircraft is associated with flight parameters including an elapsed flight time and a maximum flight time. The processing circuitry is configured to determine that a trigger operation is performed on a movement control element in a user interface. based on the trigger operation performed on the movement control element, the processing circuitry is configured to control the virtual aircraft to take off in the virtual environment. The processing circuitry is configured to determine that a first movement control operation is performed on the movement control element. based on the first movement control operation performed on the movement control element, the processing circuitry is configured to control the virtual aircraft to move in the virtual environment based on the first movement control operation. The processing circuitry is configured to determine that a second movement control operation is performed on a direction control element in the user interface. Based on the second movement control operation performed on the direction control element, the processing circuitry is configured to control the virtual object to move in the virtual environment based on the second movement control operation. The virtual object and the virtual aircraft are output for display concurrently in the first game scene, and the movement control element and the direction control element are concurrently displayed in the user interface.

An aspect of this disclosure provides a game control method which is applied to a computer device and includes the following operations: displaying a first game picture, the first game picture including a virtual object located in a virtual environment, and the virtual object holding a virtual aircraft; controlling, in response to a trigger operation of a take-off function, the virtual aircraft to take off in the virtual environment; and controlling, when a first movement control operation is detected, the virtual aircraft to move in the virtual environment based on the first movement control operation, and controlling, when a second movement control operation is detected, the virtual object to move in the virtual environment based on the second movement control operation.

An aspect of this disclosure provides a game control apparatus, including: a display module, configured to display a first game picture, the first game picture including a virtual object located in a virtual environment, and the virtual object holding a virtual aircraft; and a control module, configured to control, in response to a trigger operation of a take-off function, the virtual aircraft to take off in the virtual environment, the control module being further configured to control, when a first movement control operation is detected, the virtual aircraft to move in the virtual environment based on the first movement control operation, and control, when a second movement control operation is detected, the virtual object to move in the virtual environment based on the second movement control operation.

An aspect of this disclosure provides a computer device, including a processor and a memory, the memory having at least one program code stored therein, and the at least one program code being loaded and executed by the processor, to cause the computer device to implement any one of the foregoing game control methods.

An aspect of this disclosure provides a non-transitory computer-readable storage medium storing instructions which, when executed by a processor, cause the processor to implement any one of the foregoing game control methods.

An aspect of this disclosure provides a computer program or a computer program product. The computer program or the computer program product having at least one computer instruction stored therein, and the at least one computer instruction being loaded and executed by a processor, to cause a computer to implement any one of the foregoing game control methods.

In the technical solutions provided in the aspects of this disclosure, the virtual aircraft held by the virtual object included in the first game picture is controlled to take off in the virtual environment by the trigger operation of the take-off function, and after the virtual aircraft takes off, not only the virtual aircraft can be controlled, but also the virtual object can be controlled, so that flexibility of game control is relatively high, and operation efficiency of game control is relatively high.

In addition, after the virtual aircraft takes off in the virtual environment, while the virtual aircraft is controlled, the virtual object may further be controlled. Therefore, a player can perceive the virtual object and information around the virtual object, thereby reducing, by controlling the virtual object, a probability that the virtual object is in danger, reducing a probability that the virtual object is knocked down by a virtual object controlled by another player, improving game immersion of the player, and improving game experience of the player.

### BRIEF DESCRIPTION OF THE DRAWINGS

FIG. 1 is a schematic diagram of an implementation environment of a game control method according to an aspect of this disclosure.

FIG. 2 is a flowchart of a game control method according to an aspect of this disclosure.

FIG. 3 is a schematic diagram of display of a second game picture according to an aspect of this disclosure.

FIG. 4 is a schematic diagram of display of a reference page according to an aspect of this disclosure.

FIG. 5 is a schematic diagram of display of a first game picture according to an aspect of this disclosure.

FIG. 6 is a schematic diagram of display of another first game picture according to an aspect of this disclosure.

FIG. 7 is a schematic diagram of display of another first game picture according to an aspect of this disclosure.

FIG. 8 is a schematic diagram of a game control method according to an aspect of this disclosure.

FIG. 9 is a flowchart of a game control method according to an aspect of this disclosure.

FIG. 10 is a schematic structural diagram of a game control apparatus according to an aspect of this disclosure.

FIG. 11 is a schematic structural diagram of a terminal device according to an aspect of this disclosure.

FIG. 12 is a schematic structural diagram of a server according to an aspect of this disclosure.

### DETAILED DESCRIPTION

To make the objectives, technical solutions, and advantages of this disclosure clearer, the following describes implementations of this disclosure in further detail with reference to the accompanying drawings. The descriptions of the terms are provided as examples and are not intended to limit the scope of the disclosure.

The terms “first”, “second”, and so on in this disclosure are intended to distinguish similar objects but do not necessarily describe a specific order or sequence. Data used in such a way can be interchanged in proper circumstances, so that the aspects of this disclosure described herein can be implemented in other orders than the order illustrated or described herein. The implementations described in the following aspects do not represent all implementations consistent with this disclosure. On the contrary, the implementations are merely examples of an apparatus and a method that are consistent with some aspects of this disclosure described in detail in claims.

First, abbreviations and key terms involved in the aspects of this disclosure are defined.

A virtual environment is an environment provided (or displayed) when an application program runs on the terminal device, the virtual environment referring to an environment created for virtual objects to carry out activities. The virtual environment may be a two-dimensional virtual environment, a 2.5-dimensional virtual environment, or a three-dimensional virtual environment. The virtual environment may be a simulated environment of the real world, a semi-simulated environment of the real world, or a fictional environment. For example, the virtual environment involved in the aspects of this disclosure is a three-dimensional virtual environment.

A virtual object is a movable object in a virtual environment. The movable object may be a virtual person, a virtual animal, an animated person, or the like. Players can control virtual objects through peripheral components or by tapping a touchscreen. Each virtual object has a shape and a volume in the virtual environment, and occupies a part of space in the virtual environment. For example, when the virtual environment is a three-dimensional virtual environment, the virtual object is a three-dimensional model created based on a skeletal animation technology.

A third-person view is a viewing angle in which a in-game camera is at a position at a certain distance behind a virtual object controlled by a player, and the virtual object controlled by the player and all elements within a surrounding environment can be seen in a virtual environment.

A first-person view is a viewing angle in which a game is played at a subjective viewing angle of a player.

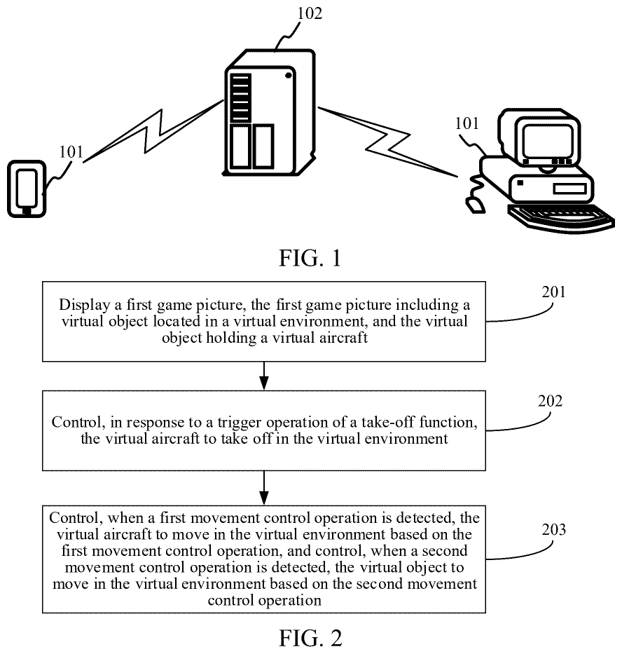

FIG. 1 is a schematic diagram of an implementation environment of a game control method according to an aspect of this disclosure. As shown in FIG. 1, the implementation environment includes a terminal device 101 and a server 102.

A game client that can provide a virtual environment is installed and run in the terminal device 101. The terminal device 101 is configured to perform the game control method according to this aspect of this disclosure.

For example, the game client that can provide a virtual environment may be a third-person shooting (TPS) game, a first-person shooting (FPS) game, a multiplayer online battle arena (MOBA) game, a multiplayer shooting survival game, a massive multiplayer online (MMO) role-playing game, an action role playing game (ARPG), a virtual reality (VR) client, an augmented reality (AR) client, a three-dimensional map program, a map simulation program, a social client, and an interactive entertainment client.

The server 102 is configured to provide background services for the game client of the terminal device 101 that can provide a virtual environment. In a possible implementation, the server 102 takes on primary computing work, and the terminal device 101 takes on secondary computing work. Alternatively, the server 102 takes on the secondary computing work, and the terminal 101 takes on the primary computing work. Alternatively, cooperative computing is performed between the terminal device 101 and the server 102 using a distributed computing architecture.

In some aspects, the terminal device 101 may be any electronic device product that may perform human-computer interaction with a user in one or more manners such as a keyboard, a touchpad, a remote control, voice interaction, or a handwriting device. For example, the terminal device 101 may be a smartphone, a tablet computer, a notebook computer, a desktop computer, a smart speaker, a smartwatch, a personal computer (PC), a mobile phone, a personal digital assistant (PDA), a wearable device, a pocket PC (PPC), a smart on-board unit, or a smart television.

The terminal device 101 may refer to one of a plurality of terminal devices. In this aspect, description is made using only the terminal device 101 as an example. It is noted that more or fewer terminal devices 101 may be used. For example, only one terminal device 101 may be used, or dozens of or hundreds of or more terminal devices 101 may be used. The quantity and the device type of the terminal devices 101 are not limited in this aspect of this disclosure.

The server 102 may be one server, a server cluster formed by a plurality of servers, or any one of a cloud computing center or a virtualization center. This is not limited in this aspect of this disclosure. The server 102 is directly or indirectly connected with the terminal device 101 in a wired or wireless communication mode. The server 102 has a data receiving function, a data processing function, and a data transmission function. The server 102 can also have other functions. This is not limited in this aspect of this disclosure.

It is noted that the terminal device 101 and the server 102 are only examples. Other existing or future possible terminal devices or servers that are applicable to this disclosure are also to be included in the scope of this disclosure, and are included herein by reference.

An aspect of this disclosure provides a game control method which is performed by a computer device. The computer device may be a terminal device. For example, the method can be applied to the implementation environment shown in FIG. 1. By using a flowchart of a game control method according to an aspect of this disclosure shown in FIG. 2 as an example, the method may be performed by the terminal device 101 in FIG. 1. As shown in FIG. 2, the method includes the following operation 201 to operation 203.

Operation 201: Display a first game picture, the first game picture including a virtual object located in a virtual environment, and the virtual object holding a virtual aircraft. For example, a first game scene including a virtual object located in a virtual environment is output for display. The virtual object is associated with a virtual aircraft. The virtual aircraft is associated with flight parameters including an elapsed flight time and a maximum flight time.

In an aspect of this disclosure, a game client that can provide a virtual environment is installed and run in the terminal device. The game client may be a client of any game. This is not limited in this aspect of this disclosure. The game client may be a game client of a first-person view, or a game client of a third-person view. The game client may be a game client based on frame synchronization. That is, the game control method according to this aspect of this disclosure can be applied to the game client based on frame synchronization.

A display interface of the terminal device has related information of the game client displayed therein. The related information of the game client may be an icon of the game client, a name of the game client, or other information that can uniquely represent the game client. This is not limited in this aspect of this disclosure. When a user wants to run the game client, the user selects the related information of the game client. That the user selects the related information of the game client may be that the user clicks on the related information of the game client, or may be that the user selects the related information of the game client in another manner. This is not limited in this aspect of this disclosure.

The user selects the related information of the game client, and the terminal device receives a trigger operation for the related information of the game client, and displays, in response to the trigger operation for the related information of the game client, a second game picture. The second game picture includes a virtual object located in a virtual environment, and the virtual object holds a virtual prop.

The virtual object is an object controlled by the user in the game client. That the virtual object holds a virtual prop may be that the virtual object holds a virtual prop by hand. In this aspect of this disclosure, the virtual prop is different from the virtual aircraft. The virtual prop may be a virtual interaction tool, or may be another type of virtual prop. The virtual aircraft may be a virtual unmanned aerial vehicle, or may be an object capable of cruising. Types of the virtual prop and the virtual aircraft are not limited in this aspect of this disclosure.

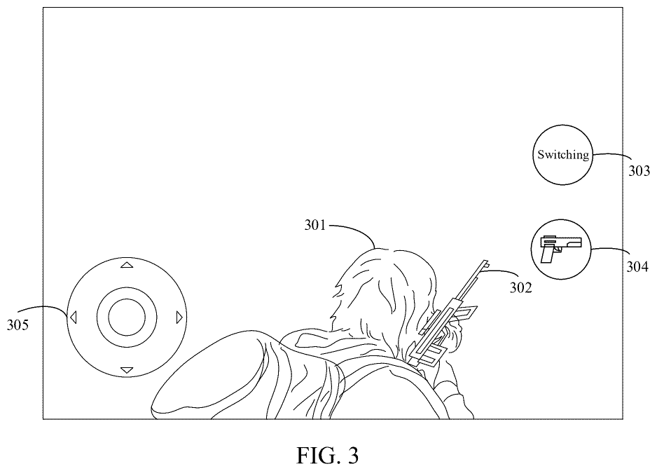

FIG. 3 is a schematic diagram of display of a second game picture according to an aspect of this disclosure. The second game picture shown in FIG. 3 has a virtual object 301 displayed therein, and the virtual object 301 holds a virtual prop 302 with hands.

In some aspects, the second game picture further has a switching control displayed therein, and the switching control is configured to switch the virtual prop held by the virtual object to the virtual aircraft. A control 303 shown in FIG. 3 is a switching control.

When the user wants to switch the virtual prop held by the virtual object to the virtual aircraft, the user clicks on the switching control, and switches, in response to a trigger operation of a switching function, the virtual prop held by the virtual object to the virtual aircraft. A first game picture is displayed, the first game picture including a virtual object located in a virtual environment, and the virtual object holding a virtual aircraft. The virtual object holding the virtual aircraft indicates that the virtual aircraft enters a pre-take-off state. The virtual object holding the virtual aircraft may be that the virtual object holds the virtual aircraft by hand. In addition, before the first game picture is displayed, displaying of the second game picture may be canceled first. In some aspects, the second game picture may be directly covered by the first game picture displayed.

In a possible implementation, a process of switching, in response to a trigger operation of a switching function, the virtual prop held by the virtual object to the virtual aircraft includes: displaying, in response to the trigger operation of the switching function, information about at least one aircraft; and switching, in response to a trigger operation for information about the virtual aircraft, the virtual prop held by the virtual object to the virtual aircraft, the virtual aircraft being any aircraft of the at least one aircraft.

The information about the aircraft includes, but is not limited to, a name of the aircraft and a picture of the aircraft. A display mode of the information about the aircraft is not limited in this aspect of this disclosure. For example, a reference page is displayed in response to the trigger operation of the switching function, and the reference page has the information about the at least one aircraft displayed therein. The reference page may be displayed in a mode of being superposed on the second game picture, or may be displayed separately. A display mode of the reference page is not limited in this aspect of this disclosure. For example, the trigger operation for the information about the virtual aircraft may be a clicking operation for the information about the virtual aircraft.

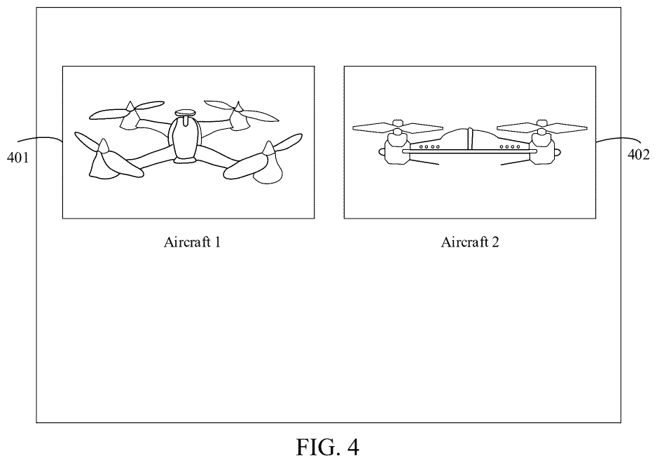

FIG. 4 is a schematic diagram of display of a reference page according to an aspect of this disclosure. The reference page shown in FIG. 4 has information about two aircraft displayed therein. A name of a first aircraft is an aircraft 1, a picture of the first aircraft is a picture indicated by 401, a name of a second aircraft is an aircraft 2, and a picture of the second aircraft is a picture indicated by 402. A quantity of the information about the aircraft displayed in the reference page may be more or less. This is not limited in this aspect of this disclosure.

In a possible implementation, a process of switching, in response to a trigger operation for information about the virtual aircraft, the virtual prop held by the virtual object to the virtual aircraft includes: switching, in response to the trigger operation for the information about the virtual aircraft and the virtual aircraft satisfying a take-off requirement, the virtual prop held by the virtual object to the virtual aircraft. The virtual aircraft satisfying a take-off requirement includes at least one of the following: the virtual aircraft being in an available occasion; a take-off quantity of the virtual aircraft being less than a take-off quantity threshold of the virtual aircraft; and the virtual object having a permission to control the virtual aircraft. The following explains and describes processes of determining different take-off requirements, respectively. For ease of description, the following processes of determining the take-off requirements are numbered, but the numbers do not represent importance and sequences, and are only intended to distinguish different take-off requirements.

### (1) Determine Whether the Virtual Aircraft is in an Available Occasion

In some aspects, based on that the virtual aircraft satisfying a take-off requirement includes the virtual aircraft being in an available occasion, when determining whether the virtual aircraft is in the available occasion, the terminal device needs to first obtain the available occasion of the virtual aircraft. For example, a process of obtaining the available occasion of the virtual aircraft includes that: the terminal device transmits an available occasion obtaining request to the server, the available occasion obtaining request including an identifier of the virtual aircraft. The server receives the available occasion obtaining request transmitted by the terminal device, and parses the available occasion obtaining request, to obtain the identifier of the virtual aircraft. The server has a mapping between an identifier of each aircraft and an available occasion of each aircraft stored therein. The server determines, according to the identifier of the virtual aircraft, and the mapping between the identifier of each aircraft and the available occasion of each aircraft, the available occasion of the virtual aircraft. The server transmits the available occasion of the virtual aircraft to the terminal device, to cause the terminal device to obtain the available occasion of the virtual aircraft. The identifier of the virtual aircraft may be a name of the virtual aircraft, a serial number of the virtual aircraft, or another identifier that can uniquely represent the virtual aircraft. This is not limited in this aspect of this disclosure.

After obtaining the available occasion of the virtual aircraft, the terminal device determines, based on that the current time is within the available occasion of the virtual aircraft, that the virtual aircraft is in the available occasion, and the virtual aircraft satisfies the take-off requirement; and determines, based on that the current time is out of the available occasion of the virtual aircraft, that the virtual aircraft is not in the available occasion, and the virtual aircraft does not satisfy the take-off requirement. The current time may refer to a time of a trigger operation for information about the virtual aircraft.

For example, if the obtained available occasion of the virtual aircraft is 10:00-14:00 each day, and the current time is 12:00, then the virtual aircraft is in the available occasion, and the virtual aircraft satisfies the take-off requirement. For another example, if the current time is 15:00, the virtual aircraft is not in the available occasion, and the virtual aircraft does not satisfy the take-off requirement.

### (2) Determine Whether a Take-Off Quantity of the Virtual Aircraft is Less Than a Take-Off Quantity Threshold of the Virtual Aircraft.

In some aspects, based on that the virtual aircraft satisfying a take-off requirement includes a take-off quantity of the virtual aircraft being less than a take-off quantity threshold of the virtual aircraft, when the terminal device determines whether the take-off quantity of the virtual aircraft is less than the take-off quantity threshold of the virtual aircraft, the terminal device needs to first obtain the take-off quantity of the virtual aircraft and the take-off quantity threshold of the virtual aircraft. A process of obtaining the take-off quantity of the virtual aircraft and the take-off quantity threshold of the virtual aircraft includes that: the terminal device transmits a quantity obtaining request to the server, the quantity obtaining request including an identifier of the virtual aircraft. The server receives the quantity obtaining request transmitted by the terminal device, and parses the quantity obtaining request, to obtain the identifier of the virtual aircraft. The server has a mapping among an identifier of each aircraft, a take-off quantity of each aircraft, and a take-off quantity threshold of each aircraft stored therein. The server determines, according to the identifier of the virtual aircraft, and the mapping among the identifier of each aircraft, the take-off quantity of each aircraft, and the take-off quantity threshold of each aircraft, the take-off quantity of the virtual aircraft and the take-off quantity threshold of the virtual aircraft. The server transmits the take-off quantity of the virtual aircraft and the take-off quantity threshold of the virtual aircraft to the terminal device, to cause the terminal device to obtain the take-off quantity of the virtual aircraft and the take-off quantity threshold of the virtual aircraft.

After obtaining the take-off quantity of the virtual aircraft and the take-off quantity threshold of the virtual aircraft, the terminal device determines, based on that the take-off quantity of the virtual aircraft is less than the take-off quantity threshold of the virtual aircraft, that the virtual aircraft satisfies the take-off requirement; and determines, based on that the take-off quantity of the virtual aircraft is not less than the take-off quantity threshold of the virtual aircraft, that the virtual aircraft does not satisfy the take-off requirement.

For example, the take-off quantity threshold may be configured in advance, and may be set based on experience, or may be adjusted according to an implementation environment. The value of the take-off quantity threshold is not limited in this aspect of this disclosure. For example, the take-off quantity threshold of the virtual aircraft is 5, and the take-off quantity of the virtual aircraft is 3. Because the take-off quantity of the virtual aircraft is less than the take-off quantity threshold, the virtual aircraft satisfies the take-off requirement. For another example, the take-off quantity of the virtual aircraft is 5. Because the take-off quantity of the virtual aircraft is not less than the take-off quantity threshold, the virtual aircraft does not satisfy the take-off requirement.

### (3) Determine Whether the Virtual Object Has a Permission to Control the Virtual Aircraft

In some aspects, based on that the virtual aircraft satisfying a take-off requirement includes the virtual object having a permission to control the virtual aircraft, the terminal device needs to determine whether the virtual object has the permission to control the virtual aircraft. For example, a process of determining whether the virtual object has the permission to control the virtual aircraft includes that: the terminal device transmits a permission obtaining request to the server, the permission obtaining request including an identifier of the virtual aircraft and an identifier of the virtual object. The server receives the permission obtaining request transmitted by the terminal device, and parses the permission obtaining request, to obtain the identifier of the virtual aircraft and the identifier of the virtual object. The server has a mapping between an identifier of each aircraft and an identifier of an object having a permission to control each aircraft stored therein. The server determines, according to the identifier of the virtual aircraft, and the mapping between the identifier of each aircraft and the identifier of the object having the permission to control each aircraft, an identifier of an object having a permission to control the virtual aircraft. A determining result is obtained according to the identifier of the virtual object and the identifier of the object having the permission to control the virtual aircraft. The determining result is configured for indicating whether the virtual object has the permission to control the virtual aircraft. The server transmits the determining result to the terminal device, to cause the terminal device to determine whether the virtual object has the permission to control the virtual aircraft.

The terminal device obtains the determining result, and determines, according to the determining result, whether the virtual object has the permission to control the virtual aircraft. Based on that the virtual object has the permission to control the virtual aircraft, the virtual aircraft satisfies the take-off requirement. Based on that the virtual object does not have the permission to control the virtual aircraft, the virtual aircraft does not satisfy the take-off requirement.

A process of obtaining the determining result according to the identifier of the virtual object and the identifier of the object having the permission to control the virtual aircraft includes that: based on that the identifier of the object having the permission to control the virtual aircraft includes the identifier of the virtual object, the determining result is that the virtual object has the permission to control the virtual aircraft. based on that the identifier of the object having the permission to control the virtual aircraft does not include the identifier of the virtual object, the determining result is that the virtual object does not have the permission to control the virtual aircraft.

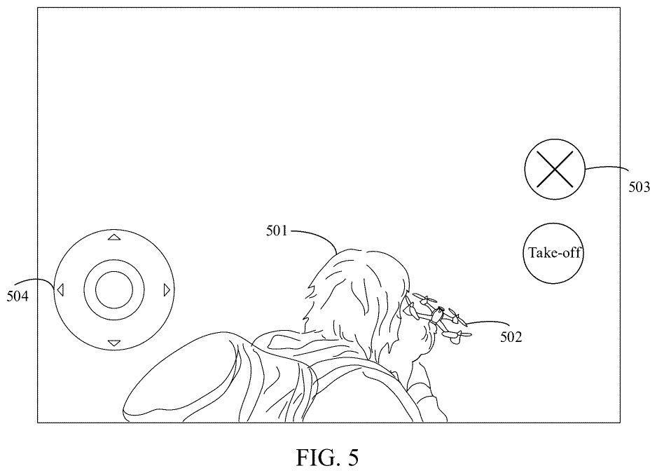

FIG. 5 is a schematic diagram of display of a first game picture according to an aspect of this disclosure. The first game picture shown in FIG. 5 has a virtual object 501 displayed therein, and the virtual object 501 holds a virtual aircraft 502.

In some aspects, the first game picture may further have a first cancellation control and a direction control displayed therein. The first cancellation control is configured to instruct to switch the virtual aircraft held by the virtual object to the virtual prop, cancel displaying of the first game picture, and display the second game picture. 503 in FIG. 5 is a first cancellation control. The direction control is configured to indicate a moving direction of the virtual object. 504 in FIG. 5 is a direction control.

In some aspects, the second game picture further has a firing control displayed therein, and the firing control is configured to instruct to cast a resource corresponding to the virtual prop. 304 in FIG. 3 is a firing control. For example, if the virtual prop is a virtual interaction tool, the firing control is configured to instruct to cast virtual ammunition corresponding to the virtual interaction tool. For another example, if the virtual prop is a virtual stick, the firing control is configured to instruct to brandish the virtual stick. For another example, if the virtual prop is a virtual knife, the firing control is configured to instruct to brandish the virtual knife.

The second game picture may further have a direction control displayed therein, and the direction control is configured to indicate a moving direction of the virtual object. 305 in FIG. 3 is a direction control. The user may freely rotate a viewing angle of the virtual object and move the virtual object by sliding the direction control in any direction. The user may control, in response to a sliding operation for the direction control in any direction, the virtual object to move in any direction. In some aspects, the user may control, in response to an upward sliding operation for the direction control, the virtual object to move forwards; control, in response to a downward sliding operation for the direction control, the virtual object to move backwards; control, in response to a leftward sliding operation for the direction control, the virtual object to move leftwards; and control, in response to a rightward sliding operation for the direction control, the virtual object to move rightwards.

The second game picture may further have other content displayed therein. This is not limited in this aspect of this disclosure. For example, the second game picture may further have another virtual object located in the virtual environment displayed therein, and the another virtual object is a virtual object controlled by another user, or the another virtual object is a virtual object controlled by a system.

Operation 202: Control, in response to a trigger operation of a take-off function, the virtual aircraft to take off in the virtual environment. For example, It is determined that trigger operation is performed on a movement control element in a user interface. Based on the trigger operation performed on the movement control element, the virtual aircraft is controlled to take off in the virtual environment.

In a possible implementation, the first game picture further has a take-off control displayed therein. The take-off control is configured to control the virtual aircraft to take off. When the user wants to let the virtual aircraft fly, the user selects the take-off control, and controls, in response to a trigger operation of a take-off function, the virtual aircraft to take off in the virtual environment. At this moment, a flight altitude of the virtual aircraft is an initial flight altitude.

The trigger operation of the take-off function may be a clicking operation for the take-off control, or may be a long press operation for the take-off control. This is not limited in this aspect of this disclosure. When the trigger operation of the take-off function refers to a long press operation for the take-off control, a duration for which the take-off control is pressed exceeds a duration threshold. In some aspects, the duration threshold is set based on experience, or adjusted according to an implementation environment. This is not limited in this aspect of this disclosure. For example, the duration threshold is three seconds.

In a possible implementation, the initial flight altitude is a flight altitude at which the virtual aircraft just takes off. The initial flight altitude is set based on experience or adjusted according to an implementation environment. This is not limited in this aspect of this disclosure. For example, the initial flight altitude is 10 meters.

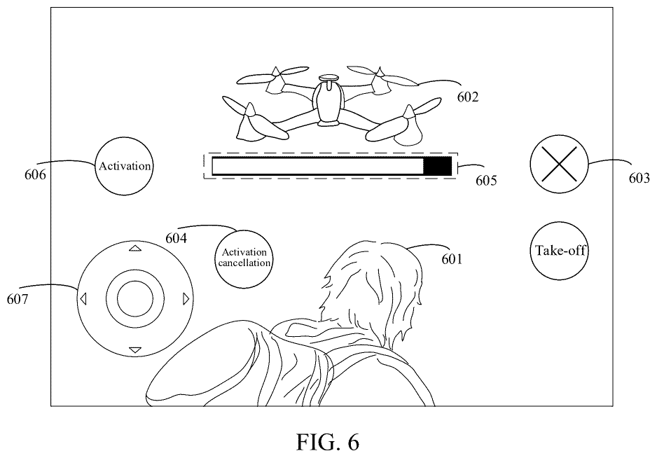

FIG. 6 is a schematic diagram of display of another first game picture according to an aspect of this disclosure. FIG. 6 has a virtual object 601 and a taken-off virtual aircraft 602 displayed therein.

In some aspects, when the trigger operation of the take-off function is a long press operation for the take-off control, after the virtual aircraft takes off, the take-off control is further long pressed, and the virtual object included in the first game picture does not hold a virtual prop. Base on that the trigger operation of the take-off function is a clicking operation for the take-off control, after the virtual aircraft takes off, when no first movement control operation is detected within a target duration, the virtual object included in the first game picture holds a virtual prop.

After the virtual aircraft takes off, the first game picture may further have a second cancellation control displayed therein. The second cancellation control is configured to cancel displaying of the first game picture and display the second game picture. 603 in FIG. 6 is a second cancellation control. After the virtual aircraft takes off in the first game picture, the first game picture not only has the taken-off virtual aircraft displayed therein, but also has the virtual object displayed therein. Therefore, the user may observe a situation around the virtual object. When the virtual object is in danger, the user may cancel control of the virtual aircraft and switch to the second game picture. In this way, after switching to the second game picture, the user does not feel wandering or unadaptable, so that virtual aircraft control experience of a player in a game can be effectively improved.

In a possible implementation, after the virtual aircraft takes off in the virtual environment, the first game picture may further have a flight duration bar of the virtual aircraft displayed therein, the flight duration bar of the virtual aircraft including at least one of a flyable duration of the virtual aircraft and a remaining flight duration of the virtual aircraft, and the flyable duration of the virtual aircraft and the remaining flight duration of the virtual aircraft being displayed in the flight duration bar of the virtual aircraft in different manners. 605 in FIG. 6 is a flight duration bar of the virtual aircraft. A white area in the flight duration bar of the virtual aircraft is configured to indicate a remaining flight duration of the virtual aircraft, and a black area in the flight duration bar of the virtual aircraft is configured to indicate a flyable duration of the virtual aircraft.

After the virtual aircraft takes off in the virtual environment, the first game picture may further have an activation control displayed therein. The activation control is configured to activate the virtual aircraft. 606 in FIG. 6 is an activation control. After controlling the virtual aircraft to take off in the virtual environment, if the user wants to activate the virtual aircraft, the user triggers the activation control. In response to a trigger operation of an activation function, and that an elapsed flight duration of the virtual aircraft is less than the flyable duration of the virtual aircraft, the user controls the virtual aircraft to throw a virtual thrower, or controls the virtual aircraft to explode. The virtual thrower is different from the virtual prop and the virtual aircraft, and the virtual thrower may be a virtual bomb.

Triggering the activation control may be clicking on the activation control. The elapsed flight duration of the virtual aircraft refers to a time difference between a take-off time of the virtual aircraft and the current time. A process of determining the elapsed flight duration of the virtual aircraft is described in the following operation 203. Details are not described herein again.

Operation 203: Control, when a first movement control operation is detected, the virtual aircraft to move in the virtual environment based on the first movement control operation, and control, when a second movement control operation is detected, the virtual object to move in the virtual environment based on the second movement control operation. For example, it is determined that a first movement control operation is performed on the movement control element. Based on the first movement control operation performed on the movement control element, the virtual aircraft is controlled to move in the virtual environment based on the first movement control operation. It is determined that a second movement control operation is performed on a direction control element in the user interface. Based on the second movement control operation performed on the direction control element, the virtual object is controlled to move in the virtual environment based on the second movement control operation. The virtual object and the virtual aircraft are output for display concurrently in the first game scene, and the movement control element and the direction control element are concurrently displayed in the user interface.

In a possible implementation, a process of controlling, when a first movement control operation is detected, the virtual aircraft to move in the virtual environment based on the first movement control operation includes: controlling, based on that the trigger operation of the take-off function is a long press operation for a take-off control, when the first movement control operation is detected based on the long press operation for the take-off control, the virtual aircraft to move in the virtual environment; and controlling, based on that the trigger operation of the take-off function is a clicking operation for the take-off control, when the first movement control operation is detected within a target duration after the clicking operation for the take-off control, the virtual aircraft to move in the virtual environment. The target duration is set based on experience, or adjusted according to an implementation environment. This is not limited in this aspect of this disclosure. For example, the target duration is three seconds. A target direction may be any direction. The location of the virtual aircraft in the virtual environment may be changed using the first movement control operation.

A process of controlling, when a first movement control operation is detected, the virtual aircraft to move in the virtual environment based on the first movement control operation includes: determining, when the first movement control operation is detected, and an elapsed flight duration of the virtual aircraft is less than a flyable duration of the virtual aircraft, an operation distance according to an operation duration of the first movement control operation; and controlling the virtual aircraft to move in the virtual environment by the operation distance.

The first movement control operation may be a dragging operation for the take-off control in a target direction. The target direction may be any direction, for example, the target direction may be upward, downward, leftward, or rightward. A process of determining the elapsed flight duration of the virtual aircraft includes: determining, according to the operation time of the trigger operation of the take-off function and a first time, the elapsed flight duration of the virtual aircraft. In some aspects, a time difference between the first time and the operation time is used as the elapsed flight duration of the virtual aircraft. The first time is the current time, and the first time changes as time passes by.

For example, the operation time is 16:08:20, Oct. 9, 2023, and the first time is 16:09:40, Oct. 9, 2023, so that the elapsed flight duration of the virtual aircraft is 1 minute and 20 seconds.

In a possible implementation, a process of determining the operation distance according to the operation duration of the first movement control operation includes: obtaining a moving speed of the virtual aircraft; and determining the operation distance according to the moving speed of the virtual aircraft and the operation duration. In some aspects, a product of the moving speed of the virtual aircraft and the operation duration is used as the operation distance.

A process of obtaining the moving speed of the virtual aircraft includes that: a moving speed obtaining request is transmitted to the server, the moving speed obtaining request including an identifier of the virtual aircraft. The server receives the moving speed obtaining request, and parses the moving speed obtaining request, to obtain the identifier of the virtual aircraft. The server has a mapping between an identifier of each aircraft and a moving speed of each aircraft stored therein. The server determines, according to the identifier of the virtual aircraft, and the mapping between the identifier of each aircraft and the moving speed of each aircraft, the moving speed of the virtual aircraft. The server transmits the moving speed of the virtual aircraft to the terminal device, to cause the terminal device to obtain the moving speed of the virtual aircraft.

In a possible implementation, based on that the trigger operation of the take-off function is a long press operation for a take-off control, in response to that the long press operation for the take-off control ends, and that the elapsed flight duration of the virtual aircraft is less than the flyable duration of the virtual aircraft, the virtual aircraft is controlled to enter an automatic cruise state. At this moment, the virtual object in the first game picture holds a virtual prop.

Alternatively, based on that the trigger operation of the take-off function is a clicking operation for the take-off control, in response to that no first movement control operation is detected within a target duration after the clicking operation for the take-off control, and that the elapsed flight duration of the virtual aircraft is less than the flyable duration of the virtual aircraft, the virtual aircraft is controlled to enter an automatic cruise state. At this moment, the virtual object in the first game picture holds a virtual prop.

That is, after the long press operation for the take-off control ends, or when no dragging operation for the take-off control is received within a target duration after the clicking operation for the take-off control, and the elapsed flight duration of the virtual aircraft is less than the flyable duration of the virtual aircraft, the virtual aircraft is controlled to enter an automatic cruise state. At this moment, the virtual object in the first game picture holds a virtual prop.

In some aspects, when the trigger operation of the take-off function is a long press operation for a take-off control, in response to that the long press operation for the take-off control ends, and that the elapsed flight duration of the virtual aircraft is less than the flyable duration of the virtual aircraft, the virtual aircraft enters an automatic cruise state, and the virtual object in the first game picture holds a virtual prop. At this moment, the virtual aircraft is automatically activated. In this case, the activation control does not need to be clicked on again to activate the virtual aircraft, so that a manner of activating the virtual aircraft is more flexible. If the user does not want to instantly activate the virtual aircraft when the long press operation ends, the user may cancel, in a setting function of the game client, automatic activation of the virtual aircraft. Alternatively, after the virtual aircraft is controlled to take off, an automatic activation cancellation control may be displayed in the first game picture. 604 in FIG. 6 is an automatic activation cancellation control. In response to a trigger operation for the automatic activation cancellation control, the virtual aircraft does not enter the automatic cruise state when the long press operation for the take-off control ends.

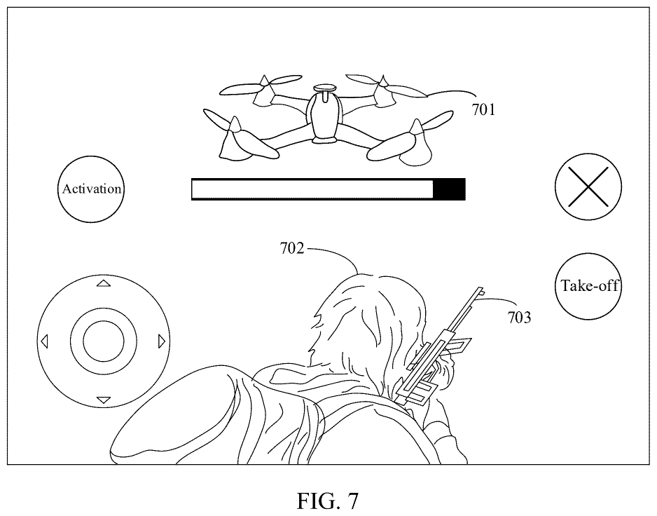

FIG. 7 is a schematic diagram of display of another first game picture according to an aspect of this disclosure. In the first game picture shown in FIG. 7, a virtual aircraft 701 is in an automatic cruise state, and a virtual object 702 holds a virtual prop 703.

In some aspects, in response to that the elapsed flight duration of the virtual aircraft is not less than the flyable duration of the virtual aircraft, displaying of the first game picture is canceled, and the second game picture is displayed. Flexible switching of game pictures can be implemented, and a flight duration of the virtual aircraft can be limited.

In a possible implementation, after the virtual aircraft takes off in the virtual environment, an activation control may further be displayed in the first game picture. The activation control is configured to activate the virtual aircraft. 606 in FIG. 6 is an activation control. When the virtual aircraft enters the automatic cruise state, and the elapsed flight duration of the virtual aircraft is less than the flyable duration of the virtual aircraft, the user triggers the activation control, and controls, in response to the trigger operation of the activation function, the virtual aircraft to throw a virtual thrower, or controls the virtual aircraft to explode.

In some aspects, after the second game picture is displayed, the second game picture has a virtual object, a switching control, and a firing control displayed therein, and the virtual object holds a virtual prop. In response to a long press operation for the switching control, the virtual prop held by the virtual object in the second game picture is switched to a virtual aircraft. The firing control is canceled to be displayed in the second game picture, and a take-off control is displayed in the second game picture. While the switching control is long pressed and the take-off control is clicked on, the virtual aircraft held by the virtual object may be controlled to take off, so that the second game picture has the virtual object and the taken-off virtual aircraft displayed therein. When a dragging operation for the switching control to a target direction is performed, the virtual aircraft is controlled to move to the target direction. After the virtual aircraft is controlled to take off, when the long press operation for the switching control is canceled, the virtual object holds a virtual prop.

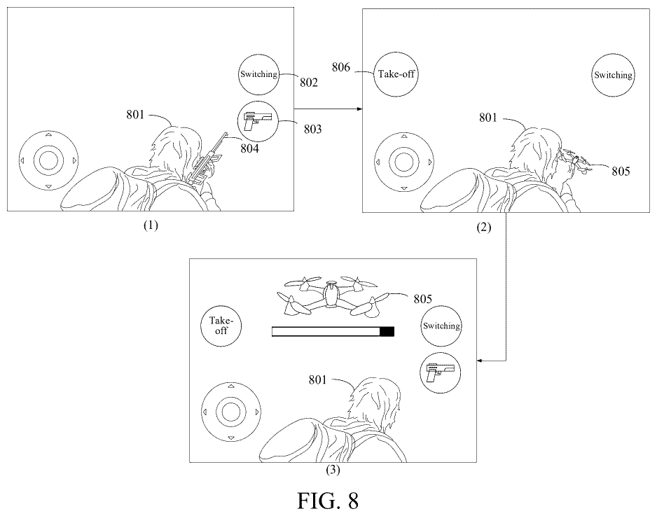

FIG. 8 is a schematic diagram of a game control method according to an aspect of this disclosure. The second game picture shown in (1) in FIG. 8 has a virtual object 801, a switching control 802, and a firing control 803 displayed therein. The virtual object 801 holds a virtual prop 804. In response to the long press operation for the switching control, (2) in FIG. 8 is displayed. The (2) in FIG. 8 has the virtual object 801 displayed therein. The virtual object holds a virtual aircraft 805. The firing control is canceled to be displayed, and a take-off control 806 is displayed. When the take-off control is clicked on while the switching control is long pressed, (3) in FIG. 8 is displayed. The (3) in FIG. 8 has the virtual object 801 and a taken-off virtual aircraft 805 displayed therein, and the virtual object 801 does not hold a virtual prop.

In some aspects, the first game picture further has a direction control displayed therein, and the direction control is configured to control movement of the virtual object. A control 607 in FIG. 6 is a direction control. The second movement control operation may be a dragging operation for the direction control in a reference direction. The reference direction may be any direction, and the reference direction may be the same as the target direction, or may be different from the target direction. This is not limited in this aspect of this disclosure. When the second movement control operation is detected, the virtual object is controlled to move in the virtual environment based on the second movement control operation. That is, when the second movement control operation is detected, the virtual object is controlled to move in the virtual environment to the reference direction.

A process of controlling, when the second movement control operation is detected, the virtual object to move in the virtual environment based on the second movement control operation includes: determining, when the second movement control operation is detected, a target distance according to an operation duration of the second movement control operation; and controlling the virtual object to move in the virtual environment by the target distance. That is, the virtual object is controlled to move in the virtual environment to the reference direction by the target distance.

A process of determining the target distance according to the operation duration of the second movement control operation includes: obtaining a moving speed of the virtual object; and determining the target distance according to the moving speed of the virtual object and the operation duration of the second movement control operation. For example, a product of the moving speed of the virtual object and the operation duration of the second movement control operation is used as the target distance. A process of determining the moving speed of the virtual object is similar to the foregoing process of determining the moving speed of the virtual aircraft. Details are not described herein again.

In a possible implementation, the first movement control operation and the second movement control operation may alternatively be a same movement control operation. For example, if the first movement control operation is performed for the virtual object, not only the virtual object may be controlled to move in the virtual environment, but also the virtual aircraft may be controlled to move in the virtual environment according to the first movement control operation, so that the virtual aircraft moves according to movement of the virtual object. For another example, if the second movement control operation is performed for the virtual aircraft, not only the virtual aircraft may be controlled to move in the virtual environment, but also the virtual object may be controlled to move in the virtual environment according to the second movement control operation, so that the virtual object moves according to movement of the virtual aircraft. In this way, a scene in which the virtual aircraft and the virtual object move synchronously under different viewing angles may be embodied.

When the first movement control operation and the second movement control operation are the same movement control operation, a movement manner, a movement direction, a movement distance, and the like of the virtual object and the virtual aircraft in the virtual environment are not limited in this aspect of this disclosure. At least one of a relative movement distance, direction, or angle of the virtual object and the virtual aircraft may be set in advance, to implement movement control on one, and synchronously perform movement control on the other, or implement movement following. That is, one of the virtual object and the virtual aircraft moves with the movement of the other.

In the foregoing method, the virtual aircraft held by the virtual object included in the first game picture is controlled to take off in the virtual environment by the trigger operation of the take-off function. After the virtual aircraft takes off, the virtual aircraft may further be controlled to move in the virtual environment when the first movement control operation is detected, and the virtual object may be controlled to move in the virtual environment when the second movement control operation is detected. According to the method, after the virtual aircraft takes off, not only the virtual aircraft can be controlled, but also the virtual object can be controlled, so that flexibility of game control is relatively high, and operation efficiency of game control is relatively high.

In addition, after the virtual aircraft takes off in the virtual environment, while the virtual aircraft is controlled, the virtual object may further be controlled. Therefore, a player can perceive the virtual object and information around the virtual object, thereby reducing, by controlling the virtual object, a probability that the virtual object is in danger, reducing a probability that the virtual object is knocked down by a virtual object controlled by another player, improving game immersion of the player, and improving game experience of the player.

In addition, when the virtual aircraft enters the automatic cruise state, the virtual aircraft may further be activated, to play a game using the virtual aircraft, so that a use manner of the virtual aircraft is more flexible. When the player cancels control of the virtual aircraft, the second game picture may be directly displayed without a change of a viewing angle, so that the player does not feel wandering or unadaptable, thereby further improving game experience of the player.

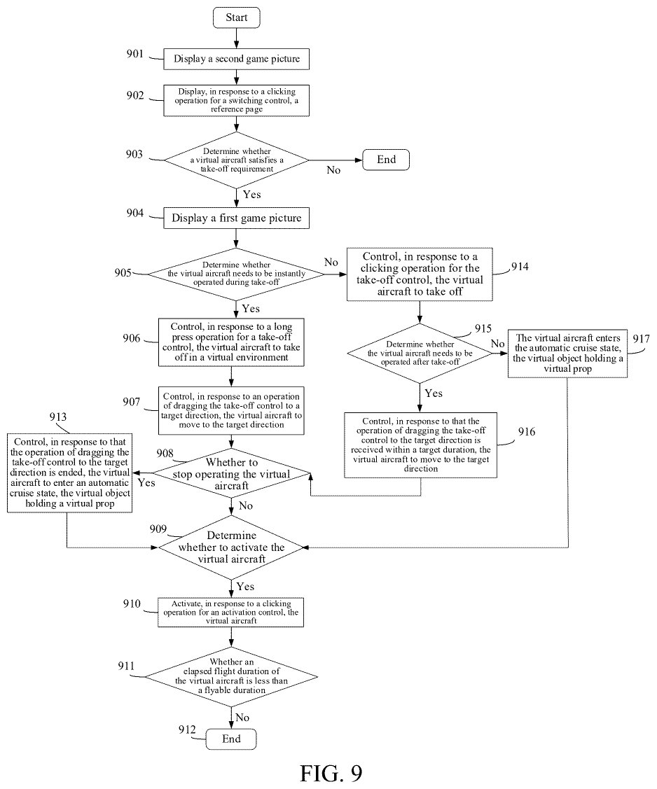

FIG. 9 is a flowchart of a game control method according to an aspect of this disclosure. As shown in FIG. 9, the method includes the following operation 901 to operation 917.

901: Display a second game picture.

The second game picture includes a virtual object and a switching control located in a virtual environment, and the virtual object holds a virtual prop.

902: Display, in response to a clicking operation for the switching control, a reference page.

The reference page has information about at least one aircraft displayed therein.

For content of operation 901 and operation 902, reference can be made to related descriptions related to displaying the second game picture and the reference page in operation 201. Details are not described herein again.

903: Determine, in response to a click operation for the information about the virtual aircraft, whether the virtual aircraft satisfies a take-off requirement.

For content of operation 903, reference can be made to related descriptions related to determining whether the virtual aircraft satisfies a take-off requirement in operation 201. Details are not described herein again.

904: Display a first game picture based on that the virtual aircraft satisfies the take-off requirement.

Based on that the virtual aircraft satisfies the take-off requirement, the virtual prop held by the virtual object is switched to the virtual aircraft, and the first game picture is displayed. The first game picture includes the virtual object in the virtual environment and a take-off control. The virtual object holds the virtual aircraft, and the take-off control is configured to control the virtual aircraft to take off.

For content of operation 904, reference can be made to related descriptions related to displaying the first game picture in operation 201 and operation 202. Details are not described herein again.

The process is ended based on that the virtual aircraft does not satisfy the take-off requirement.

905: Determine whether the virtual aircraft needs to be instantly operated during take-off.

906: Control, based on that the virtual aircraft needs to be instantly operated during take-off, in response to a long press operation for the take-off control, the virtual aircraft to take off in the virtual environment.

907: Control, in response to an operation of dragging the take-off control to a target direction, the virtual aircraft to move to the target direction.

908: Determine whether to stop operating the virtual aircraft.

909: Determine, based on not stopping operating the virtual aircraft, whether to activate the virtual aircraft.

910: Activate, based on activating the virtual aircraft, in response to a clicking operation for the activation control, the virtual aircraft.

911: Determine whether an elapsed flight duration of the virtual aircraft is less than a flyable duration.

912: End the process based on that the elapsed flight duration of the virtual aircraft is not less than the flyable duration.

Based on that the elapsed flight duration of the virtual aircraft is less than the flyable duration, the take-off control may continue to be dragged to continue to control movement of the virtual aircraft.

913: Control, based on stopping operating the virtual aircraft, in response to that the operation of dragging the take-off control to the target direction is ended, the virtual aircraft to enter an automatic cruise state, the virtual object holding a virtual prop.

After the virtual aircraft enters the automatic cruise state, operation 909 to operation 912 may further be performed to determine whether to activate the virtual aircraft and whether to end the process.

914: Control, based on that the virtual aircraft does not need to be instantly operated during take-off, in response to a clicking operation for the take-off control, the virtual aircraft to take off.

915: Determine whether the virtual aircraft needs to be operated after take-off.

916: Control, based on that the virtual aircraft needs to be operated after take-off, in response to that the operation of dragging the take-off control to the target direction is received within a target duration, the virtual aircraft to move to the target direction.

After the virtual aircraft is operated after take-off, operation 908 to operation 912 may further be performed to determine whether to stop operating the virtual aircraft, whether to activate the virtual aircraft, and whether to end the process.

917: Control, based on a determination that the virtual aircraft does not need to be operated after take-off, the virtual aircraft to enter the automatic cruise state, the virtual object holding a virtual prop.

After the virtual aircraft enters the automatic cruise state, operation 909 to operation 912 may further be performed to determine whether to activate the virtual aircraft and whether to end the process.

In addition, for content of operation 905 to operation 917, reference can be made to related descriptions of operation 202 and operation 203. Details are not described herein again.

According to the foregoing method, the take-off control is controlled to control the virtual aircraft to take off in the virtual environment, so that control of the virtual aircraft is more flexible. After the virtual aircraft is controlled to take off, because the first game picture not only has the take-off virtual aircraft displayed therein, but also has the virtual object displayed therein. Therefore, after the virtual aircraft takes off, a player can still perceive the virtual object and information around the virtual object, thereby reducing a probability that the virtual object is in danger, reducing a probability that the virtual object is knocked down by a virtual object controlled by another player, improving game immersion of the player, and improving game experience of the player.

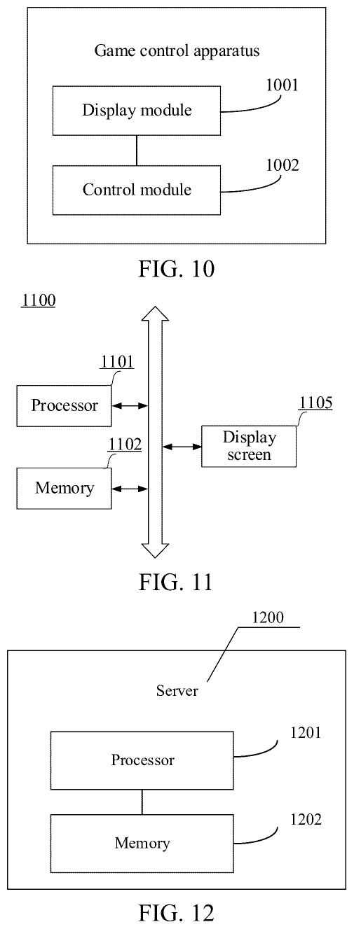

FIG. 10 is a schematic structural diagram of a game control apparatus according to an aspect of this disclosure. As shown in FIG. 10, the apparatus includes:
a display module 1001, configured to display a first game picture, the first game picture including a virtual object located in a virtual environment, and the virtual object holding a virtual aircraft; and
a control module 1002, configured to control, in response to a trigger operation of a take-off function, the virtual aircraft to take off in the virtual environment,
the control module 1002 being further configured to control, when a first movement control operation is detected, the virtual aircraft to move in the virtual environment based on the first movement control operation, and control, when a second movement control operation is detected, the virtual object to move in the virtual environment based on the second movement control operation.

In a possible implementation, the display module 1001 is configured to display a second game picture, the second game picture including the virtual object located in the virtual environment, the virtual object holding a virtual prop, and the virtual prop being different from the virtual aircraft; switch, in response to a trigger operation of a switching function, the virtual prop held by the virtual object to the virtual aircraft; and display the first game picture.

In a possible implementation, the display module 1001 is configured to display, in response to the trigger operation of the switching function, a reference page, the reference page having information about at least one aircraft displayed therein; and switch, in response to a trigger operation for information about the virtual aircraft, the virtual prop held by the virtual object to the virtual aircraft, the virtual aircraft being any aircraft of the at least one aircraft.

In a possible implementation, the display module 1001 is configured to switch, in response to the trigger operation for the information about the virtual aircraft and the virtual aircraft satisfying a take-off requirement, the virtual prop held by the virtual object to the virtual aircraft.

In a possible implementation, the virtual aircraft satisfying a take-off requirement includes at least one of the following: the virtual aircraft being in an available occasion; a take-off quantity of the virtual aircraft being less than a take-off quantity threshold of the virtual aircraft; and the virtual object having a permission to control the virtual aircraft.

In a possible implementation, the first game picture further has a first cancellation control and a direction control displayed therein;

the first cancellation control being configured to instruct to switch the virtual aircraft held by the virtual object to the virtual prop, cancel displaying of the first game picture, and display the second game picture; and the direction control being configured to indicate a moving direction of the virtual object.

In a possible implementation, the first game picture further has a second cancellation control displayed therein, the second cancellation control being configured to cancel, after the virtual aircraft takes off, displaying of the first game picture, and display the second game picture.

In a possible implementation, the control module 1002 is configured to determine, when the first movement control operation is detected, and an elapsed flight duration of the virtual aircraft is less than a flyable duration of the virtual aircraft, an operation distance according to an operation duration of the first movement control operation; and control the virtual aircraft to move in the virtual environment by the operation distance.

In a possible implementation, the control module 1002 is configured to obtain a moving speed of the virtual aircraft; and determine the operation distance according to the moving speed of the virtual aircraft and the operation duration.

In a possible implementation, the control module 1002 is configured to control, based on that the trigger operation of the take-off function is a long press operation for a take-off control, when the first movement control operation is detected based on the long press operation for the take-off control, the virtual aircraft to move in the virtual environment; and control, based on that the trigger operation of the take-off function is a clicking operation for the take-off control, when the first movement control operation is detected within a target duration after the clicking operation for the take-off control, the virtual aircraft to move in the virtual environment.

In a possible implementation, the control module 1002 is further configured to control, based on that the trigger operation of the take-off function is a long press operation for a take-off control, in response to that the long press operation for the take-off control ends, and that the elapsed flight duration of the virtual aircraft is less than the flyable duration of the virtual aircraft, the virtual aircraft to enter an automatic cruise state; and control, based on that the trigger operation of the take-off function is a clicking operation for the take-off control, in response to that no first movement control operation is detected within a target duration after the clicking operation for the take-off control, and that the elapsed flight duration of the virtual aircraft is less than the flyable duration of the virtual aircraft, the virtual aircraft to enter an automatic cruise state.

In a possible implementation, the display module 1001 is configured to cancel, in response to that the elapsed flight duration of the virtual aircraft is not less than the flyable duration of the virtual aircraft, displaying of the first game picture, and display the second game picture.

In a possible implementation, the control module 1002 is further configured to control, in response to a trigger operation of an activation function, when the elapsed flight duration of the virtual aircraft is less than the flyable duration of the virtual aircraft, the virtual aircraft to throw a virtual thrower, or control the virtual aircraft to explode.

In a possible implementation, the control module 1002 is further configured to control, in response to a trigger operation of an activation function, and that the elapsed flight duration of the virtual aircraft is less than the flyable duration of the virtual aircraft, the virtual aircraft to throw a virtual thrower, or control the virtual aircraft to explode.

In a possible implementation, based on that the virtual aircraft takes off in the virtual environment, the first game picture further has a flight duration bar of the virtual aircraft displayed therein, the flight duration bar of the virtual aircraft including at least one of a flyable duration of the virtual aircraft and a remaining flight duration of the virtual aircraft, and the flyable duration of the virtual aircraft and the remaining flight duration of the virtual aircraft being displayed in the flight duration bar of the virtual aircraft in different manners.

In the foregoing apparatus, the virtual aircraft held by the virtual object included in the first game picture is controlled to take off in the virtual environment by the trigger operation of the take-off function. After the virtual aircraft takes off, the virtual aircraft may further be controlled to move in the virtual environment when the first movement control operation is detected, and the virtual object may be controlled to move in the virtual environment when the second movement control operation is detected. After the virtual aircraft takes off, not only the virtual aircraft can be controlled, but also the virtual object can be controlled, so that flexibility of game control is relatively high, and operation efficiency of game control is relatively high.

In addition, after the virtual aircraft takes off in the virtual environment, while the virtual aircraft is controlled, the virtual object may further be controlled. Therefore, a player can perceive the virtual object and information around the virtual object, thereby reducing, by controlling the virtual object, a probability that the virtual object is in danger, reducing a probability that the virtual object is knocked down by a virtual object controlled by another player, improving game immersion of the player, and improving game experience of the player.

When the apparatus provided above implements the functions of the apparatus, only division into the foregoing function modules is used as an example for description. In the practical application, the functions may be allocated to and completed by different function modules according to requirements. That is, an internal structure of the device is divided into different function modules, to complete all or some of the functions described above. In addition, the apparatus and method aspects provided in the foregoing aspects belong to a same conception. For the specific implementation process, reference can be made to the method aspects. Details are not described herein again.

FIG. 11 is a structural block diagram of a terminal device 1100 according to an aspect of this disclosure. The terminal device 1100 may be any electronic device product that may perform human-computer interaction with a user in one or more manners such as a keyboard, a touchpad, a remote control, voice interaction, or a handwriting device. For example, a PC, a mobile phone, a smartphone, a PDA, a wearable device, a PPC, a tablet computer, a smart on-board unit, a smart television, a smart speaker, or a smartwatch.

The terminal device 1100 includes a processor 1101 (an example of processing circuitry) and a memory 1102 (an example of a non-transitory computer-readable storage medium).

The processor 1101 may include one or more processing cores, for example, a 4-core processor or an 8-core processor. The processor 1101 may be implemented in at least one hardware form of a digital signal processing (DSP), a field-programmable gate array (FPGA), and a programmable logic array (PLA). The processor 1101 may alternatively include a main processor and a coprocessor. The main processor is a processor configured to process data in an awake state, and is also referred to as a central processing unit (CPU). The coprocessor is a low power consumption processor configured to process the data in a standby state. In some aspects, the processor 1101 may have a graphics processing unit (GPU) integrated therein. The GPU is configured to render and draw content that needs to be displayed on a display screen. In some aspects, the processor 1101 may further include an artificial intelligence (AI) processor. The AI processor is configured to process computing operations related to machine learning.

The memory 1102 may include one or more computer-readable storage media. The computer-readable storage medium may be non-transient. The memory 1102 may further include a high-speed random access memory and a non-volatile memory, for example, one or more disk storage devices or flash storage devices. In some aspects, the non-transient computer-readable storage medium in the memory 1102 is configured to store at least one instruction. The at least one instruction is configured for being executed by the processor 1101 to implement the game control method provided in the method aspects of this disclosure.

In some aspects, the terminal device 1100 may alternatively include: a display screen 1105. The display screen 1105 is configured to display a user interface (UI). The UI may include a graph, text, an icon, a video, and any combination thereof. When the display screen 1105 is a touch display screen, the display screen 1105 further has a capability of acquiring a touch signal on or above a surface of the display screen 1105. The touch signal may be input to the processor 1101 as a control signal for processing. In this case, the display screen 1105 may be further configured to provide a virtual button and/or a virtual keyboard, also referred to as a soft button and/or a soft keyboard. In some aspects, the display screen 1105 may be one, set on a front panel of the terminal device 1100. In some other aspects, the display screen 1105 may be at least two, arranged on different surfaces of the terminal device 1100 or in a folded design, respectively. In some other aspects, the display screen 1105 may be a flexible display screen, arranged on a curved surface or a folded surface of the terminal device 1100. Alternatively, the display screen 1105 may be even arranged in a non-rectangular irregular pattern, namely, a special-shaped screen. The display screen 1105 may be prepared using a material such as a liquid crystal display (LCD), an organic light-emitting diode (OLED), or the like.

It is noted that the structure shown in FIG. 11 constitutes no limitation on the terminal device 1100, and the terminal device 1100 may include more or fewer components than those shown in the figure, or a combination of some components, or have a different arrangement of components.

FIG. 12 is a schematic structural diagram of a server according to an aspect of this disclosure. The server 1200 may vary a lot due to different configurations or performance, and may include one or more CPUs 1201 and one or more memories 1202. The one or more memories 1202 have at least one program code stored therein, and the at least one program code is loaded and executed by the one or more CPUs 1201 to implement the game control method provided in the foregoing method aspects. The server 1200 may further have assemblies such as a wired or wireless network interface, a keyboard, and an input/output interface for inputting and outputting. The server 1200 may further include other assemblies configured to implement device functions, and details are not described herein.

In an aspect, a computer device is further provided. The computer device includes a processor and a memory, the memory having at least one program code stored therein, and the at least one program code being loaded and executed by the processor, to cause the computer device to implement any one of the foregoing game control methods.

In an aspect, a non-volatile computer-readable storage medium, such as a non-transitory computer-readable storage medium, is further provided, the non-volatile computer-readable storage medium has at least one program code stored therein, and the at least one program code is loaded and executed by a processor, to cause a computer to implement any one of the foregoing the game control methods.

In some aspects, the foregoing computer-readable storage medium may be a read-only memory (ROM), a random access memory (RAM), a compact disc read-only memory (CD-ROM), a magnetic tape, a floppy disk, an optical data storage device, or the like.

In an aspect, a computer program or a computer program product is further provided, the computer program or the computer program product has at least one computer instruction stored therein, and the at least one computer instruction is loaded and executed by a processor, to cause a computer to implement any one of the foregoing the game control methods.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“A plurality of” mentioned in this specification means two or more. “And/or” describes an association relationship for describing associated objects and represents that three relationships may exist. For example, A and/or B may represent the following three cases: Only A exists, both A and B exist, and only B exists. The character “/” indicates an “or” relationship between the associated objects.

The foregoing descriptions are merely example aspects of this disclosure, and are not intended to limit this disclosure. Any modification, equivalent replacement, or improvement made within the principle of this disclosure shall fall within the scope of this disclosure.

What is claimed is:

1. A game control method, comprising:
outputting for display a first game scene including a virtual object located in a virtual environment, the virtual object being associated with a virtual aircraft, the virtual aircraft being associated with flight parameters including an elapsed flight time and a maximum flight time;
determining that a trigger operation is performed on a movement control element in a user interface;
based on the trigger operation performed on the movement control element, controlling the virtual aircraft to take off in the virtual environment;
determining that a first movement control operation is performed on the movement control element;
based on the first movement control operation performed on the movement control element, controlling the virtual aircraft to move in the virtual environment based on the first movement control operation;
determining that a second movement control operation is performed on a direction control element in the user interface; and
based on the second movement control operation performed on the direction control element, controlling the virtual object to move in the virtual environment based on the second movement control operation, wherein
the virtual object and the virtual aircraft are output for display concurrently in the first game scene, and the movement control element and the direction control element are concurrently displayed in the user interface.

2. The method according to claim 1, further comprising:
outputting for display a second game scene including the virtual object located in the virtual environment, the virtual object being associated with a virtual prop;
based on a switching operation performed on a switching control element in the user interface, switching the virtual prop associated with the virtual object to the virtual aircraft; and
outputting for display the first game scene.

3. The method according to claim 2, wherein the switching the virtual prop to the virtual aircraft comprises:
outputting for display, based on the switching operation, at least one selectable aircraft; and
based on a selection operation performed on one of the at least one selectable aircraft, switching the virtual prop to the selected aircraft as the virtual aircraft.

4. The method according to claim 3, wherein the switching the virtual prop to the selected aircraft is performed when the selected aircraft satisfies a take-off requirement.

5. The method according to claim 4, wherein the take-off requirement includes at least one of:
the selected aircraft being in an available time period;
a take-off count of the selected aircraft being less than a take-off count threshold of the selected aircraft; and
the virtual object having control permission for the selected aircraft.

6. The method according to claim 2, wherein the user interface further includes a first cancel control element, wherein a trigger operation performed on the first cancel control element causes:
the virtual aircraft to be switched to the virtual prop,
outputting for display of the first game scene to be canceled, and
the second game scene to be output for display.

7. The method according to claim 1, wherein the user interface further includes a second cancel control element, wherein a trigger operation performed on the second cancel control element causes:
the outputting for display of the first game scene to be canceled, and
a second game scene to be output for display.

8. The method according to claim 1, wherein the controlling the virtual aircraft to move based on the first movement control operation comprises:
determining, when the elapsed flight time of the virtual aircraft is less than the maximum flight time of the virtual aircraft, an operation distance based on a duration of the first movement control operation; and
controlling the virtual aircraft to move in the virtual environment based on the operation distance.

9. The method according to claim 8, wherein the determining the operation distance comprises:
obtaining a movement speed of the virtual aircraft; and
determining the operation distance based on the movement speed and the duration of the first movement control operation.

10. The method according to claim 1, wherein the trigger operation performed on the movement control element includes a long-press operation or a click operation performed on the movement control element, and the controlling the virtual aircraft to move comprises:
controlling, based on the long-press operation performed on the movement control element, the virtual aircraft to move in the virtual environment during the long-press operation; and
controlling, based on the click operation performed on the movement control element, the virtual aircraft to move in a target duration based on the click operation.

11. The method according to claim 10, further comprising:
controlling, based on termination of the long-press operation performed on the movement control element, and when the elapsed flight time of the virtual aircraft is less than the maximum flight time of the virtual aircraft, the virtual aircraft to enter an automatic cruise state; and
controlling, based on the click operation performed on the movement control element, and when no first movement control operation is detected within the target duration while the elapsed flight time of the virtual aircraft is less than the maximum flight time of the virtual aircraft, the virtual aircraft to enter the automatic cruise state.

12. The method according to claim 1, further comprising:
based on the elapsed flight time of the virtual aircraft being not less than the maximum flight time of the virtual aircraft,
canceling the outputting for display of the first game scene, and
outputting for display a second game scene.

13. The method according to claim 1, further comprising:
based on an activation operation performed on an activation control element in the user interface, and when the elapsed flight time of the virtual aircraft is less than the maximum flight time of the virtual aircraft, controlling the virtual aircraft to launch a virtual projectile or initiate an explosion.

14. The method according to claim 1, wherein the first game scene includes a flight duration indicator of the virtual aircraft, the flight duration indicator indicating at least one of the maximum flight time of the virtual aircraft and a remaining flight time of the virtual aircraft.

15. A game control apparatus, comprising:
processing circuitry configured to:
output for display a first game scene including a virtual object located in a virtual environment, the virtual object being associated with a virtual aircraft, the virtual aircraft being associated with flight parameters including an elapsed flight time and a maximum flight time;
determine that a trigger operation is performed on a movement control element in a user interface;
based on the trigger operation performed on the movement control element, control the virtual aircraft to take off in the virtual environment;
determine that a first movement control operation is performed on the movement control element;
based on the first movement control operation performed on the movement control element, control the virtual aircraft to move in the virtual environment based on the first movement control operation;
determine that a second movement control operation is performed on a direction control element in the user interface; and
based on the second movement control operation performed on the direction control element, control the virtual object to move in the virtual environment based on the second movement control operation, wherein
the virtual object and the virtual aircraft are output for display concurrently in the first game scene, and the movement control element and the direction control element are concurrently displayed in the user interface.

16. The apparatus according to claim 15, wherein the processing circuitry is configured to:
output for display a second game scene including the virtual object located in the virtual environment, the virtual object being associated with a virtual prop;
based on a switching operation performed on a switching control element in the user interface, switch the virtual prop associated with the virtual object to the virtual aircraft; and
output for display the first game scene.

17. The apparatus according to claim 16, wherein the processing circuitry is configured to:
output for display, based on the switching operation, at least one selectable aircraft; and
based on a selection operation performed on one of the at least one selectable aircraft, switch the virtual prop to the selected aircraft as the virtual aircraft.

18. The apparatus according to claim 17, wherein the virtual prop is switched to the selected aircraft when the selected aircraft satisfies a take-off requirement.

19. The apparatus according to claim 18, wherein the take-off requirement includes at least one of:
the selected aircraft being in an available time period;
a take-off count of the selected aircraft being less than a take-off count threshold of the selected aircraft; and
the virtual object having control permission for the selected aircraft.

20. A non-transitory computer-readable storage medium storing instructions which, when executed by a processor, cause the processor to perform:
outputting for display a first game scene including a virtual object located in a virtual environment, the virtual object being associated with a virtual aircraft, the virtual aircraft being associated with flight parameters including an elapsed flight time and a maximum flight time;
determining that a trigger operation is performed on a movement control element in a user interface;
based on the trigger operation performed on the movement control element, controlling the virtual aircraft to take off in the virtual environment;
determining that a first movement control operation is performed on the movement control element;
based on the first movement control operation performed on the movement control element, controlling the virtual aircraft to move in the virtual environment based on the first movement control operation;
determining that a second movement control operation is performed on a direction control element in the user interface; and
based on the second movement control operation performed on the direction control element, controlling the virtual object to move in the virtual environment based on the second movement control operation, wherein
the virtual object and the virtual aircraft are output for display concurrently in the first game scene, and the movement control element and the direction control element are concurrently displayed in the user interface.
